(19) United States
(12) Patent Application Publication
(10) Pub. No.: US 2016/0268692 A1
(43) Pub. Date: Sep. 15, 2016

(54) ANTENNA DEVICE

(71) Applicant: FUJITSU LIMITED, Kawasaki-shi (JP)

(72) Inventor: Yohei KOGA, Kawasaki (JP)

(21) Appl. No.: 14/997,388

(22) Filed: Jan. 15, 2016

(30) Foreign Application Priority Data
Mar. 9, 2015 (JP) 2015-046132

(51) Int. Cl. H01Q 17/00; H01Q 9/16; H01Q 7/06; H01Q 9/30

(52) U.S. Cl. CPC H01Q 17/004; H01Q 9/30; H01Q 17/007; H01Q 9/16; H01Q 7/06

(57) ABSTRACT

An antenna device includes: an antenna element that has a feeding point; and a floating conductive element that is arranged so as to extend in a direction in which a current flows in the antenna element and in vicinity of the antenna element at a position corresponding to an anti-node of the current, and that is configured to relax a current distribution at the anti-node and around the anti-node.

### CROSS-REFERENCE TO RELATED APPLICATION

This application is based upon and claims the benefit of priority of the prior Japanese Patent Application No. 2015-046132, filed on Mar. 9, 2015, the entire contents of which are incorporated herein by reference.

### FIELD

The embodiments discussed herein are related to an antenna device.

### BACKGROUND

In the related art, there is a communication terminal device that has an antenna that radiates electromagnetic waves and an antenna ground that has a rectangular or substantially rectangular shape and is electrically connected to the antenna. The communication terminal device includes an elongated conductive member that is electrically connected to the antenna ground. The conductive member is arranged in the vicinity of a hot spot where the level of electromagnetic waves from the antenna is high when the conductive member is not present and is arranged so as to extend in a direction orthogonal to a longitudinal direction of the antenna ground (for example, refer to Japanese Laid-open Patent Publication No. 2005-150998).

The communication terminal device of the related art is provided with the conductive member in order to reduce the electromagnetic field in the vicinity of the conductive member so as to improve a specific absorption rate (SAR) characteristic. Consequently, there is a problem in that the radiation efficiency of the antenna is degraded.

Accordingly, an object is to provide an antenna device that reduces an SAR characteristic without degrading radiation efficiency.

### SUMMARY

According to an aspect of the embodiments, an antenna device includes: an antenna element that has a feeding point; and a floating conductive element that is arranged so as to extend in a direction in which a current flows in the antenna element and in vicinity of the antenna element at a position corresponding to an anti-node of the current, and that is configured to relax a current distribution at the anti-node and around the anti-node.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B illustrate a simulation model of a monopole antenna device, which is for comparison, and a phantom;

FIG. 2 is a characteristics diagram that illustrates the relationship between the length of an antenna element and an SAR value;

FIGS. 3A and 3B illustrate an SAR distribution and a current distribution generated by the antenna device, which is for comparison;

FIGS. 4A and 4B illustrate antenna devices of an embodiment;

FIGS. 5A, 5B, 5C, and 5D are diagrams for explaining an SAR reduction effect;

FIGS. 6A and 6B illustrate the SAR distributions of antenna devices;

FIGS. 7A and 7B illustrate an antenna device, which is for comparison, and the frequency characteristics of an S parameter;

FIGS. 8A, 8B, 8C, 8D, 8E, and 8F illustrate floating elements according to modifications of Embodiment 1;

FIGS. 9A and 9B illustrate antenna devices according to modifications of Embodiment 1;

FIGS. 10A, 10B, and 10C are diagrams for explaining an SAR reduction effect in Embodiment 2;

FIG. 11 illustrates an antenna device according to a modification of Embodiment 2;

FIG. 12 illustrates an SAR and antenna efficiency in Embodiment 2; and

FIGS. 13A, 13B, 13C, and 13D are diagrams for explaining an SAR reduction effect.

### DESCRIPTION OF EMBODIMENTS

Hereafter, embodiments in which an antenna device is applied will be described.

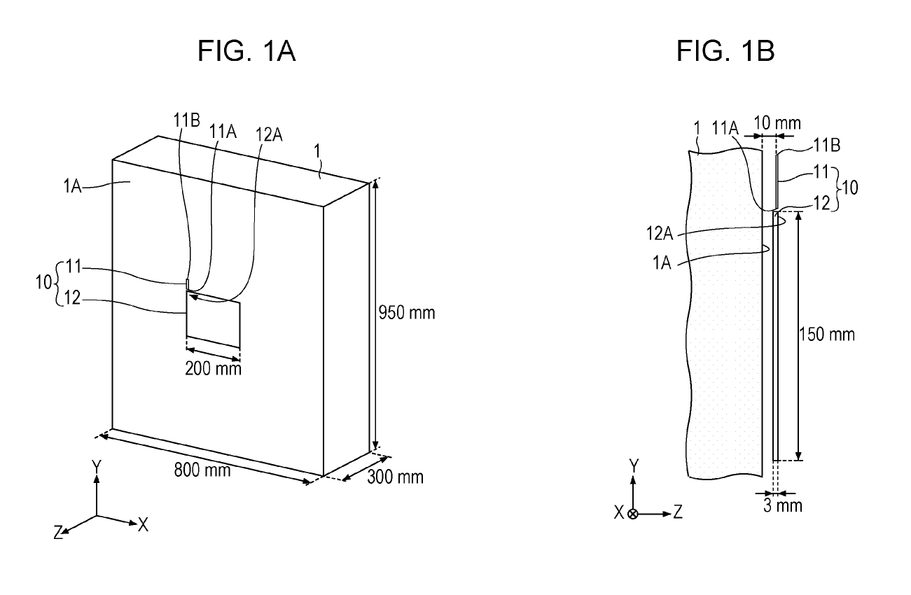

FIGS. 1A and 1B are respectively a perspective view and a side view of a simulation model of a monopole antenna device 10, which is for comparison, and a phantom 1. Here, a specific absorption rate (SAR) distribution generated by the antenna device 10 will be analyzed using electromagnetic field simulation. An XYZ coordinate system will be used as a Cartesian coordinate system.

The phantom 1 is a simulated human body that has electrical characteristics that are equivalent to the electrical characteristics of biological tissue (dielectric constant and conductivity). Here, as an example, a phantom is used that has a rectangular parallelepiped shape having a length of 800 mm in the X axis direction, a length of 950 mm in the Y axis direction and a length of 300 mm in the Z axis direction, and that has a relative dielectric constant of 48.7 and a conductivity of 5.82 S/m.

The antenna device 10 includes a monopole antenna element 11 and a ground plane 12, and is arranged on a positive Z-axis direction side of the phantom 1 in the vicinity of a surface 1A that is parallel to the XY plane. The antenna element 11 and the ground plane 12 are conductors and for example may be composed of copper, aluminum or the like.

Here, although the antenna element 11 and the ground plane 12 are illustrated as being the constituent elements of the antenna device 10 as a result of the antenna device 10 being illustrated as a simulation model, the antenna element 11 and the ground plane 12 may be formed on a substrate made of an insulating body when the antenna device 10 is actually manufactured.

The antenna element 11 includes a feeding point 11A that is disposed in the vicinity of a vertex 12A of the ground plane 12 and a tip 11B, and extends in the Y axis direction. The antenna element 11 is a line-shaped conductor that is arranged at a position that is a distance of 10 mm from the surface 1A in the Z axis direction.

The ground plane 12 is a flat-plate-shaped conductor that has a length of 200 mm in the X axis direction, a length of 150 mm in the Y axis direction and a length (thickness) of 3 mm in the Z axis direction, and is maintained at the ground potential. The distance between the ground plane 12 and the surface 1A is around 7 mm.

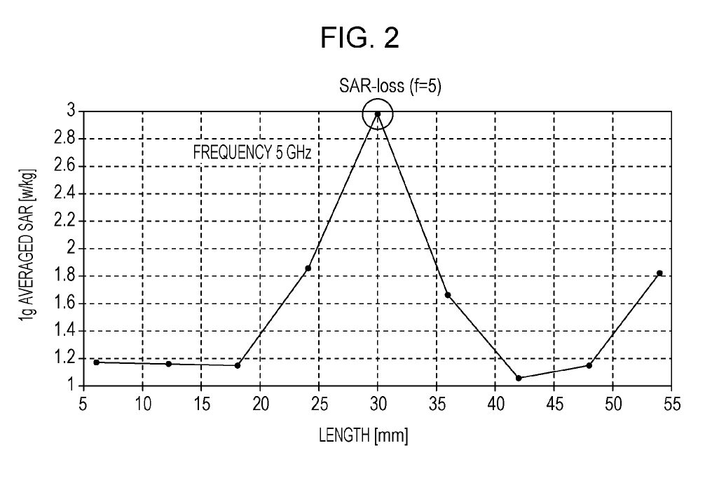

FIG. 2 is a characteristics diagram that illustrates the relationship between the length of the antenna element 11 and an SAR value.

A simulation was performed by changing the length of the antenna element 11 from around 5 mm to around 55 mm under a condition where the frequency of radio waves received by the antenna element 11 (refer to FIG. 1) was set to 5 GHz. The results illustrated in FIG. 2 were obtained.

The antenna element 11 was a perfect conductor and the length of the antenna element 11 was changed such that perfect matching was achieved. That is, the width and the thickness of the antenna element 11 were fixed and occurrence of matching loss was avoided, and the radiation efficiency was 100% even though the length of the antenna element changed.

In addition, the wavelength (λ) at 5 GHz was around 60 mm. The values of SAR were obtained as an absorption rate (w/kg) averaged over 1 g of the phantom 1.

As a result, it was found that the value of SAR is maximum when the length of the antenna element 11 is 30 mm. This means that the value of SAR becomes maximum when the length of the antenna element 11 is λ/2 and it is thought that the value of SAR is increased by a second harmonic.

Thus, since the value of SAR for absorption by the phantom 1 is maximum when the length of the antenna element 11 is λ/2, an evaluation is performed below in which the length of the antenna element 11 is fixed at λ/2. Hereafter, the antenna element 11 is a monopole antenna with a length of λ/2 (harmonic monopole antenna).

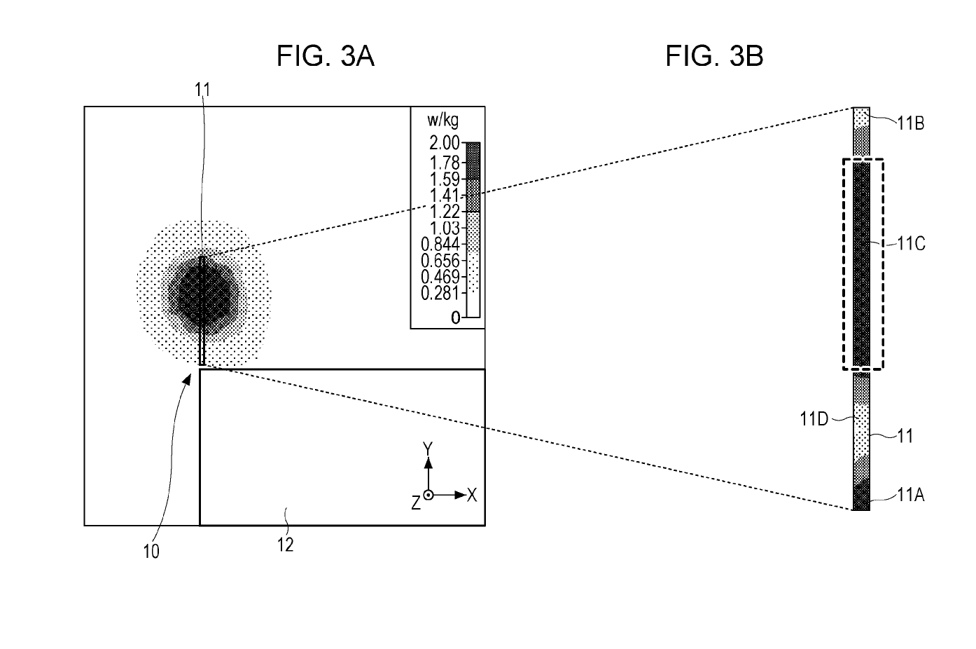

FIGS. 3A and 3B illustrate a SAR distribution and a current distribution generated by the antenna device 10, which is for comparison. The antenna device 10 is arranged in the vicinity of the phantom 1 as illustrated in FIG. 1. In FIG. 3A, the outlines of the antenna element 11 and part of the ground plane 12 are illustrated. In FIG. 3B, the current distribution in a part of FIG. 3A corresponding to the antenna element 11 is illustrated in an enlarged manner.

In the SAR distribution illustrated in FIG. 3A, a darker color indicates a region with a higher SAR value and a lighter color (white) indicates a region with a lower SAR value. Similarly, in the current distribution illustrated in FIG. 3B, a darker color indicates a region with a higher current value and a lighter color (white) indicates a region with a lower current value.

Comparing the SAR distribution of FIG. 3A and the current distribution of FIG. 3B, it is clear there is a correlation between the SAR distribution and the current distribution. That is, it is clear that a region in which the SAR value is high and a region in which the current value is high substantially coincide with each other and that a region in which the SAR value is low and a region in which the current value is low substantially coincide with each other.

In the monopole antenna element 11, a point where the current is maximum is the position of an anti-node of a resonant current flowing in the antenna element 11 and a point where the current is a minimum is the position of a node of the resonant current. In the monopole antenna element 11, a node of the current is at the tip 11B.

In the monopole antenna element 11 having a length of λ/2, an anti-node 11C of the resonant current is located closer to the tip 11B than a point in the middle between the feeding point 11A and the tip 11B. In FIG. 3B, in the region indicated by a broken line, the current value is high and a point in the center of the region indicated by the broken line in the length direction is the position of the anti-node 11C. In addition, there is another node 11D between the anti-node 11C and the feeding point 11A.

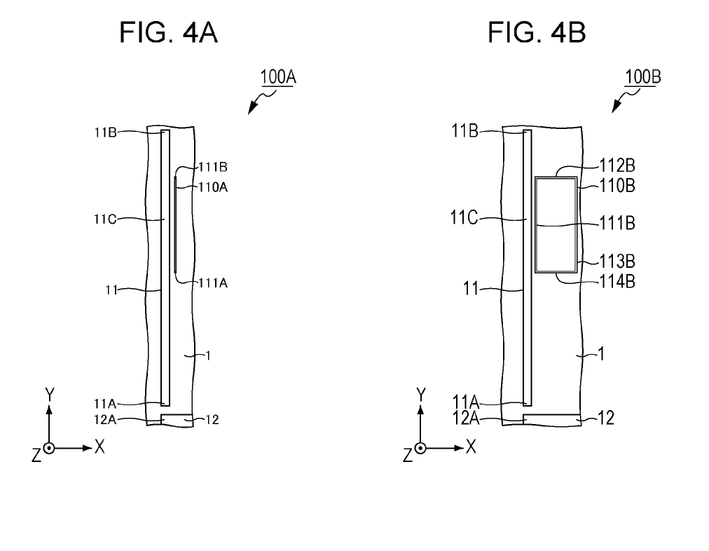

FIGS. 4A and 4B illustrate antenna devices 100A and 100B of the embodiment. The antenna devices 100A and 100B are arranged in the vicinity of the phantom 1, similarly to the antenna device 10 illustrated in FIG. 1. In FIGS. 4A and 4B, the same XYZ coordinate system as in FIG. 1 is used.

The antenna device 100A illustrated in FIG. 4A includes the antenna element 11, the ground plane 12 and a floating element 110A. The antenna element 11 is an example of an antenna element. The ground plane 12 is an example of a ground plate.

The width of the antenna element 11 in the X axis direction is to be set to a suitable width in accordance with the characteristic impedance and so forth and is 3 mm, for example.

The floating element 110A is a line-shaped conductor that is maintained at a floating potential and is an example of a floating conductive element. The floating element 110A is arranged in the vicinity of the antenna element 11 so as to extend along the antenna element 11 at a position corresponding to the anti-node 11C of the resonant current of the antenna element 11. The antenna element 11, the ground plane 12 and the floating element 110A are arranged in the same XY plane.

Here, the antenna device 100A is illustrated as a simulation model, and for example the antenna element 11, the ground plane 12 and the floating element 110A may be formed on a substrate made of an insulating body when the antenna device 100A is actually manufactured.

Here, “maintained at a floating potential” means not directly fed from the feeding point 11A and floating from a reference potential such as the ground potential. That is, the floating element 110A is not connected to the antenna element 11 and is also not connected to the ground plane 12.

Furthermore, “a position corresponding to the anti-node 11C of the resonant current” means that the floating element 110A, which is arranged parallel to antenna element 11 in the vicinity of the antenna element 11, is arranged at a position where part of the floating element 110A overlaps the anti-node 11C of the resonant current flowing in the antenna element 11 in the length direction (Y axis direction).

Moreover, in addition to this, “a position corresponding to the anti-node 11C of the resonant current” means that the floating element 110A is arranged in the vicinity of the antenna element 11 such that, even if no part of the floating element 110A overlaps the anti-node 11C of the resonant current flowing in the antenna element 11 in the length direction (Y axis direction), the floating element 110A is still able to relax the current at the anti-node 11C.

The floating element 110A is arranged in the vicinity of the antenna element 11 so as to extend along the antenna element 11 at a position corresponding to the anti-node 11C in order to relax the current at the anti-node 11C by causing the floating element 110A to electromagnetic-field couple with the antenna element 11 at the part of the antenna element 11 where the value of the current is highest.

The length of the floating element 110A is less than half the wavelength λ (less than λ/2) at the communication frequency of the antenna device 100A. This is so that a resonant current is not generated in the floating element 110A.

Here, the length of the floating element 110A in the Y axis direction is 10 mm and the width of the floating element 110A in the X axis direction is 0.2 mm. As an example, the floating element 110A is arranged 0.5 mm from the antenna element 11 in the X axis direction and parallel to the antenna element 11.

Generation of a resonant current is to be avoided mainly in order to maintain or improve the radiation characteristics of the antenna device 100A despite the addition of the floating element 110A.

As a result of arranging the above-described floating element 110A in the antenna device 100A, the anti-node 11C of the resonant current and the current distribution around the anti-node 11C are relaxed while maintaining the radiation efficiency.

In addition, the antenna device 100B illustrated in FIG. 4 includes the antenna element 11, the ground plane 12 and a floating element 110B. The floating element 110B is a rectangular-loop-shaped conductor that is maintained at a floating potential and is an example of a floating conductive element. The floating element 110B is arranged in the vicinity of the antenna element 11 so as to extend along the antenna element 11 at a position corresponding to the anti-node 11C of the resonant current of the antenna element 11.

The floating element 110B includes lines 111B, 112B, 113B and 114B, the lines 111B and 113B forming the long edges and the lines 112B and 114B forming the short edges of the floating element 110B. The line 111B is arranged in the vicinity of the antenna element 11 similarly to the floating element 110A illustrated in FIG. 4A.

The length of the lines 111B and 113B is 10 mm and the length of the lines 112B and 114B is 4.2 mm. The width of the lines 111B, 112B, 113B and 114B is 0.2 mm.

Here, the antenna device 100B is illustrated as a simulation model, and for example the antenna element 11, the ground plane 12 and the floating element 110B may be formed on a substrate made of an insulating body when the antenna device 100B is actually manufactured.

Here, “maintained at a floating potential” means not directly fed from the feeding point 11A and floating from a reference potential such as the ground potential. That is, the floating element 110B is not connected to the antenna element 11 and is also not connected to the ground plane 12.

Furthermore, “a position corresponding to the anti-node 11C of the resonant current” means that the floating element 110B, which is arranged parallel to antenna element 11 in the vicinity of the antenna element 11, is arranged at a position where part of the floating element 110B overlaps the anti-node 11C of the resonant current flowing in the antenna element 11 in the length direction (Y axis direction).

Furthermore, in addition to this, “a position corresponding to the anti-node 11C of the resonant current” means that the floating element 110B is arranged in the vicinity of the antenna element 11 such that, even if no part of the floating element 110B overlaps the anti-node 11C of the resonant current flowing in the antenna element 11 in the length direction (Y axis direction), the floating element 110B is still able to relax the current at the anti-node 11C.

The floating element 110B is arranged in the vicinity of the antenna element 11 so as to extend along the antenna element 11 at a position corresponding to the anti-node 11C in order to relax the current at the anti-node 11C by causing the floating element 110B to electromagnetic-field couple with the antenna element 11 at the part of the antenna element 11 where the value of the current is highest.

In addition, the length of the rectangular loop of the floating element 110B is less than the wavelength λ (less than λ) at the communication frequency of the antenna device 100B. This is in order that a resonant current is not generated in the floating element 110B due to the floating element 110B behaving like a loop antenna.

Generation of a resonant current is to be avoided mainly in order to maintain or improve the radiation characteristics of the antenna device 100B despite the addition of the floating element 110B.

As a result of arranging the above-described floating element 110B in the antenna device 100B, the anti-node 11C of the resonant current and the current distribution around the anti-node 11C are relaxed while maintaining the radiation efficiency.

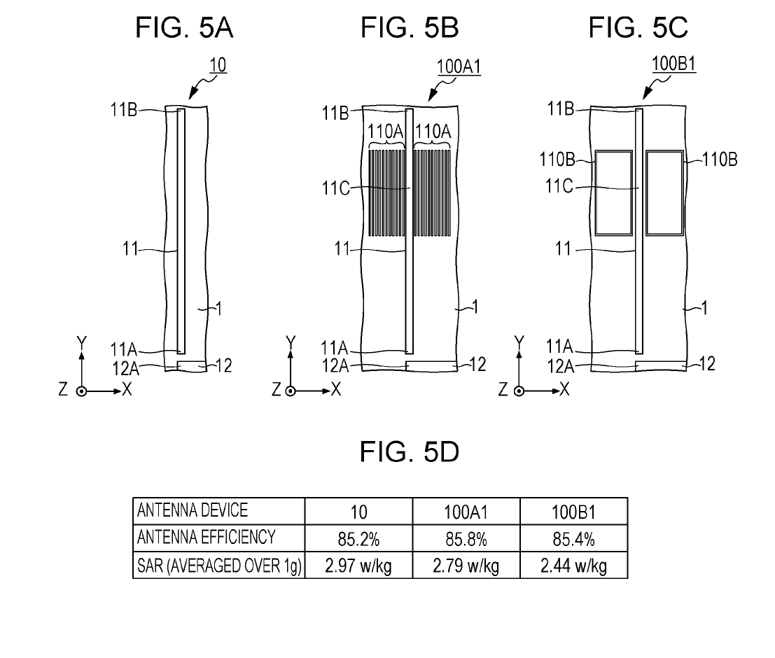

FIGS. 5A to 5D are diagrams for explaining an SAR reduction effect. In FIGS. 5A to 5C, the same XYZ coordinate system is used as in FIGS. 1, 4A and 4B.

The antenna device 10 illustrated in FIG. 5A is the same as the antenna device 10 illustrated in FIG. 1 and includes the antenna element 11 and the ground plane 12.

An antenna device 100A1 illustrated in FIG. 5B includes the antenna element 11, the ground plane 12 and a plurality of floating elements 110A. In the antenna device 100A1 illustrated in FIG. 5B, as well as the floating element 110A of the antenna device 100A illustrated in FIG. 4A being arranged on both sides of the anti-node 11C of the antenna element 11, a plurality of the floating elements 110A are arranged parallel to each other and so as to be spaced apart from each other in the X axis direction on each side of the antenna element 11.

In addition, an antenna device 100B1 illustrated in FIG. 5C includes the antenna element 11, the ground plane 12 and floating elements 110B. In the antenna device 100B1 illustrated in FIG. 5C, the floating element 110B of the antenna device 100B illustrated in FIG. 4B is arranged on both sides of the anti-node 11C of the antenna element 11.

The obtained simulation results for antenna efficiency (radiation efficiency) and SAR for these antenna devices 10, 100A1 and 100B1 are illustrated in FIG. 5D.

As illustrated in FIG. 5D, the antenna efficiency and the SAR of the antenna device 10 were 85.2% and 2.97 w/kg, respectively. In contrast, the antenna efficiency and the SAR of the antenna device 100A1 were 85.8% and 2.79 w/kg, respectively, and the antenna efficiency and the SAR of the antenna device 100B1 were 85.4% and 2.44 w/kg, respectively.

Thus, the antenna efficiencies of the antenna devices 100A1 and 100B1 were equal to or higher than the antenna efficiency of the antenna device 10 and the SARs of the antenna devices 100A1 and 100B1 were lower than the SAR of the antenna device 10. In particular, the SAR of the antenna device 100B1 was substantially improved from the SAR of the antenna device 10 and was reduced by around 17.5%.

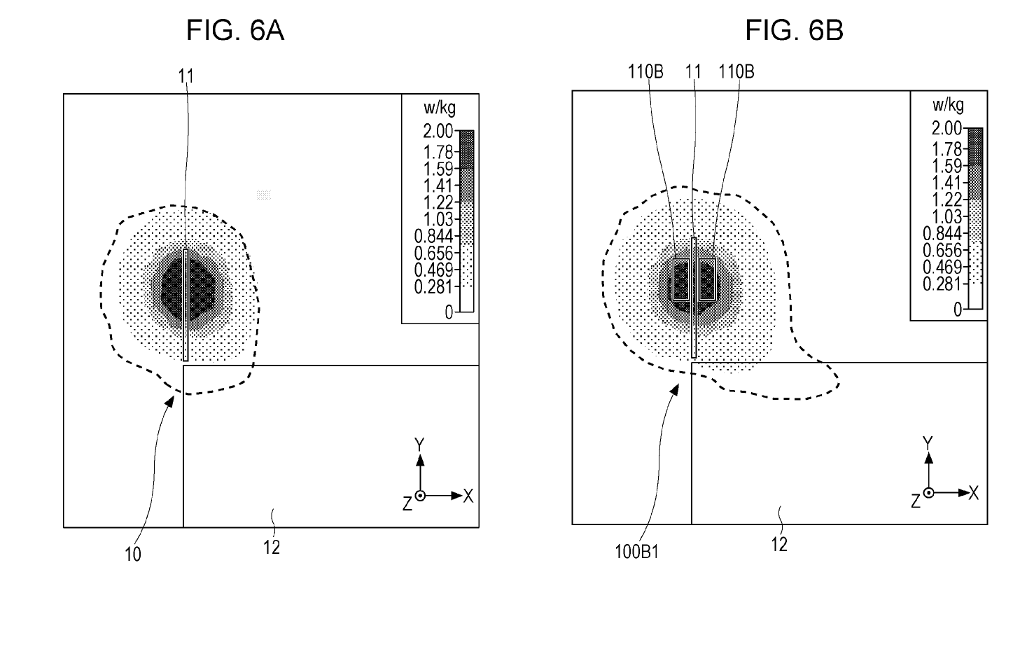

FIGS. 6A and 6B illustrate the SAR distributions of the antenna devices 10 and 100B1. These are simulation results obtained by electromagnetic field simulation. In the SAR distributions illustrated in FIGS. 6A and 6B, a darker color indicates a region with a higher SAR value and a lighter color (white) indicates a region with a lower SAR value.

The SAR distribution of the antenna device 10 illustrated in FIG. 6A is the same as the SAR distribution illustrated in FIG. 3A and the part of the distribution with the highest SAR value is shifted toward the tip of the antenna element 11 from the center of the antenna element 11 in the length direction. This part corresponds to the anti-node 11C of the resonant current generated in the antenna element 11 and it is clear that the anti-node 11C is at the center and that a region in which the SAR value is high is concentrated around the anti-node 11C. The region in which the SAR value is increased by the antenna device 10 is indicated by a broken line.

The SAR distribution of the antenna device 100B1 illustrated in FIG. 6B has a part where the SAR value is highest at the anti-node 11C (refer to FIG. 5C) generated by the antenna element 11 and around the anti-node 11C. However, compared with the distribution illustrated in FIG. 6A, the region having the darkest color (region having highest SAR value) is narrower and the distribution is wider overall. The region in which the SAR value is increased by the antenna device 100B1 is indicated by a broken line.

Thus, it is clear that the SAR distribution for the antenna device 100B1 containing two loop-shaped floating elements 110B is dispersed compared to the SAR distribution for the antenna device 10. Since there is a correlation between the SAR distribution and the current distribution as described above, the current distribution will be relaxed in the antenna device 100B1 containing two loop-shaped floating elements 110B compared to in the antenna device 10.

According to Embodiment 1 described above, the antenna devices 100A, 100A1, 100B and 100B1 may be provided that cause the SAR distribution to be dispersed, due to the inclusion of the floating elements 110A and 110B, while maintaining the radiation efficiency.

A mode in which a monopole antenna element 11 is used has been described above, but a dipole antenna element may be used instead of a monopole antenna element. The floating elements 110A and 110B may be arranged at positions that correspond to anti-nodes of a resonant current of the dipole antenna element.

In addition, the length of each part was described above using the wavelength (λ) at the communication frequency, but the lengths may be set by considering wavelength shortening and/or electrical length when actually manufacturing the antenna element 11 and so forth.

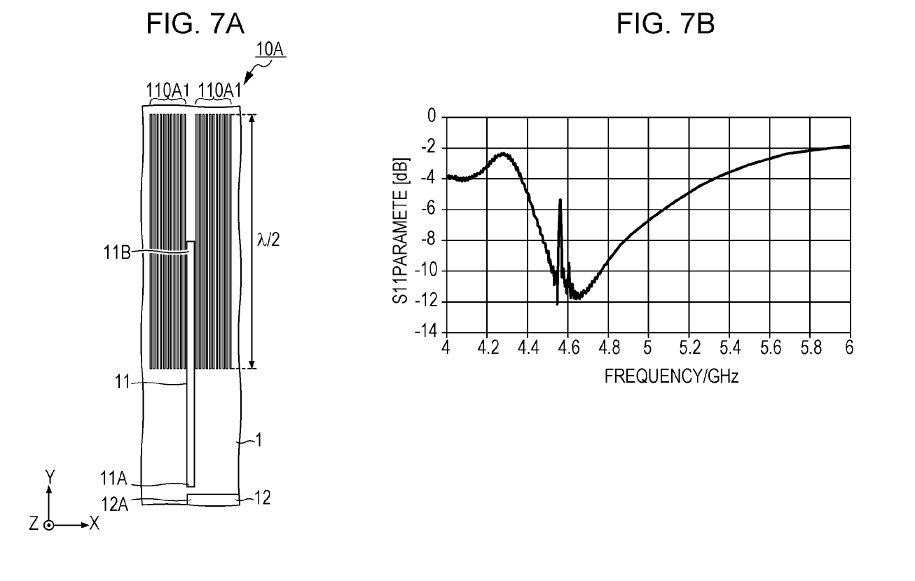

FIGS. 7A and 7B illustrate an antenna device 10A, which is for comparison, and the frequency characteristics of an S parameter.

The antenna device 10A illustrated in FIG. 7A includes the antenna element 11, the ground plane 12 and a plurality of floating elements 110A1. The antenna element 11 and the ground plane 12 are the same as the antenna element 11 and the ground plane 12 of the antenna device 100A1 illustrated in FIG. 5B.

The floating elements 110A1 are obtained by setting the length of the floating elements 110A of the antenna device 100A1 illustrated in FIG. 5B to be half the wavelength λ at the communication frequency (λ/2) and arranging the centers of the floating elements 110A in the length direction to match the position of the tip 11B of the antenna element 11.

The antenna element 11 is a monopole antenna with a length of λ/2 (harmonic monopole antenna).

When the frequency of radio waves that communicate with the above-described antenna device 10A is changed from 4 GHz to 6 GHz, as illustrated in FIG. 7B, the minimum value (around −12 dB) of an S11 parameter is obtained at around 4.65 GHz, but the value of the S11 parameter steeply rises up to around −6 dB at around 4.55 GHz.

It is thought that, at around 4.55 GHz, a resonant current flows in the floating elements 110A and as a result the value of the S11 parameter steeply rises.

Therefore, it is preferable that the length of the floating elements 110A be set to less than half the wavelength λ (λ/2) so that resonance does not occur at the communication frequency.

Modes in which a line-shaped floating element 110A and a rectangular loop-shaped floating element 110B are used have been described above, but a floating element with a shape other than these shapes may be used.

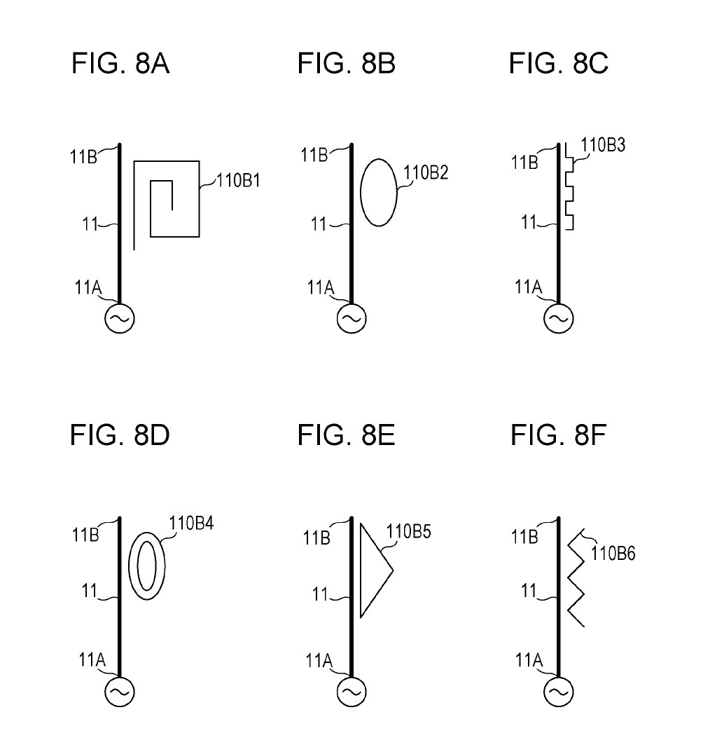

FIGS. 8A to 8F illustrate floating elements according to modifications of Embodiment 1.

A rectangular spiral shape may be used as in a floating element 110B1 illustrated in FIG. 8A. The entire length of the floating element 110B1 is preferably less than half the wavelength λ at the communication frequency (less than λ/2). The floating element 110B1 may be provided on both sides of the antenna element 11.

An elliptical loop shape may be used as in a floating element 110B2 illustrated in FIG. 8B. The entire length of the floating element 110B2 is preferably less than the wavelength λ at the communication frequency (less than λ). The floating element 110B2 may be provided on both sides of the antenna element 11.

A meandering shape may be used as in a floating element 110B3 illustrated in FIG. 8C. The entire length of the floating element 110B3 is preferably less than half the wavelength λ at the communication frequency (less than λ/2). The floating element 110B3 may be provided on both sides of the antenna element 11.

A double elliptical loop arrangement may be used as in a floating element 110B4 illustrated in FIG. 8D. The total entire length of the two floating elements 110B4 is preferably less than the wavelength λ at the communication frequency (less than λ). The floating element 110B4 may be provided on both sides of the antenna element 11.

A triangular loop shape may be used as in a floating element 110B5 illustrated in FIG. 8E. The entire length of the floating element 110B5 is preferably less than the wavelength λ at the communication frequency (less than λ). The floating element 110B5 may be provided on both sides of the antenna element 11.

A zig-zag shape may be used as in a floating element 110B6 illustrated in FIG. 8F. The entire length of the floating element 110B6 is preferably less than half the wavelength λ at the communication frequency (less than λ/2). The floating element 110B6 may be provided on both sides of the antenna element 11.

Modes have been described above in which the antenna element 11 and the floating elements 110A, 110B and 110B1 to 110B6 are arranged in the same XY plane. However, the floating elements 110A, 110B and 110B1 to 110B6 may be arranged at a different position to the antenna element 11 in the Z axis direction.

For example, if a floating element that is arranged at a different position in the Z axis direction to the antenna element 11 and the floating elements 110A, 110B and 110B1 to 110B6 is added, the floating elements are arranged three-dimensionally with respect to the antenna element 11.

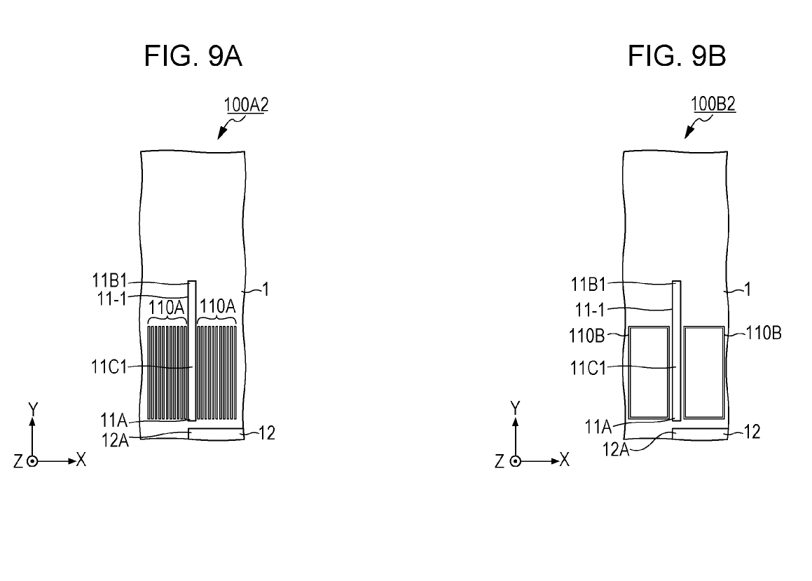

FIGS. 9A and 9B illustrate antenna devices according to modifications of Embodiment 1.

An antenna device 100A2 illustrated in FIG. 9A includes an antenna element 11-1, the ground plane 12 and the floating elements 110A. The floating elements 110A are the same as the floating elements 110A illustrated in FIG. 5B.

The antenna element 11-1 has a length of λ/4 from the feeding point 11A to a tip 11B1. That is, half the length of the antenna element 11 illustrated in FIG. 5B.

The tip 11B1 of the antenna element 11-1, which has a length of λ/4, becomes a node (zero current) of the resonant current and the feeding point 11A becomes an anti-node of the resonant current. Consequently, the floating elements 110A of the antenna device 100A2 illustrated in FIG. 9A are arranged at a position that corresponds to the feeding point 11A, which is where the anti-node of the resonant current is located.

In addition, an antenna device 100B2 illustrated in FIG. 9B includes the antenna element 11-1, the ground plane 12 and the floating elements 110B. The floating elements 110B are the same as the floating elements 110B illustrated in FIG. 5C.

The antenna element 11-1 is the same as the antenna element 11-1 illustrated in FIG. 9A and the length of the antenna element 11-1 from the feeding point 11A to the tip 11B1 is λ/4. That is, half the length of the antenna element 11 illustrated in FIG. 5C.

The tip 11B1 of the antenna element 11-1, which has a length of λ/4, becomes a node (zero current) of the resonant current and the feeding point 11A becomes an anti-node of the resonant current. Consequently, the floating elements 110B of the antenna device 100B2 illustrated in FIG. 9B are arranged at a position that corresponds to the feeding point 11A, which is where the anti-node of the resonant current is located.

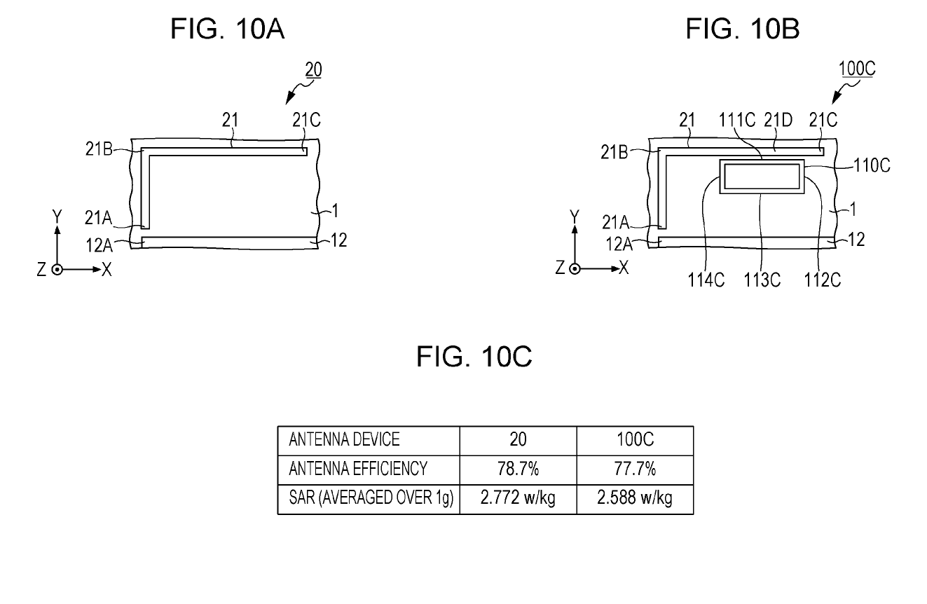

FIGS. 10A to 10C are diagrams for explaining an SAR reduction effect in Embodiment 2. In FIGS. 10A and 10B, the same XYZ coordinate system as in FIGS. 1, 4A, 4B and 5A to 5C is used.

An antenna device 20, which is for comparison, illustrated in FIG. 10A is obtained by replacing the antenna element 11 of the antenna device 10 illustrated in FIG. 1 with an inverted L-shaped antenna element 21. That is, the antenna device 20 includes the antenna element 21 and the ground plane 12. The antenna element 21 has a feeding point 21A, a bent portion 21B and a tip 21C. The antenna element 21 is an example of an antenna element.

The antenna element 21 extends in the positive direction along the Y axis from the feeding point 21A to the bent portion 21B, is bent through a right angle at the bent portion 21B, and the extends in the positive direction along the X axis to the tip 21C.

The length from the feeding point 21A to the tip 21C via the bent portion 21B is less than half the wavelength λ at the communication frequency of the antenna device 20. The antenna element 21 is a monopole antenna with a length of λ/2 (harmonic monopole antenna).

More specifically, the length of the antenna element 21 is 30 mm for a communication frequency of 5 GHz, the length from the feeding point 21A to the bent portion 21B being 10 mm and the length from the bent portion 21B to the tip 21C being 20 mm.

An antenna device 100C of Embodiment 2 illustrated in FIG. 10B includes the antenna element 21, the ground plane 12 and a floating element 110C. The floating element 110C illustrated in FIG. 10B is the same as the floating element 110B of the antenna device 100B illustrated in FIG. 4B and is arranged at a position corresponding to an anti-node 21D of a resonant current in the antenna element 21.

The floating element 110C includes lines 111C, 112C, 113C and 114C, the lines 111C and 113C forming the long edges and the lines 112C and 114C forming the short edges. The line 111C is the same as the line 111B of the floating element 110B illustrated in FIG. 4B and is arranged in the vicinity of the antenna element 21.

The lengths of the lines 111C and 113C are 10 mm and the lengths of the lines 112C and 114C are 4.2 mm. The widths of the lines 111C, 112C, 113C and 114C are 0.6 mm.

The obtained simulation results for antenna efficiency (radiation efficiency) and SAR for the antenna devices 20 and 100C are illustrated in FIG. 10C.

As illustrated in FIG. 10C, the antenna efficiency and the SAR of the antenna device 20 were 78.7% and 2.772 w/kg, respectively. In contrast, the antenna efficiency and the SAR of the antenna device 100C were 77.7% and 2.588 w/kg, respectively.

Thus, the antenna efficiency of the antenna device 100C is substantially the same as the antenna efficiency of the antenna device 20 and the difference in antenna efficiency would not be a problem practically. In addition, the SAR of the antenna device 100C is lower than the SAR of the antenna device 20.

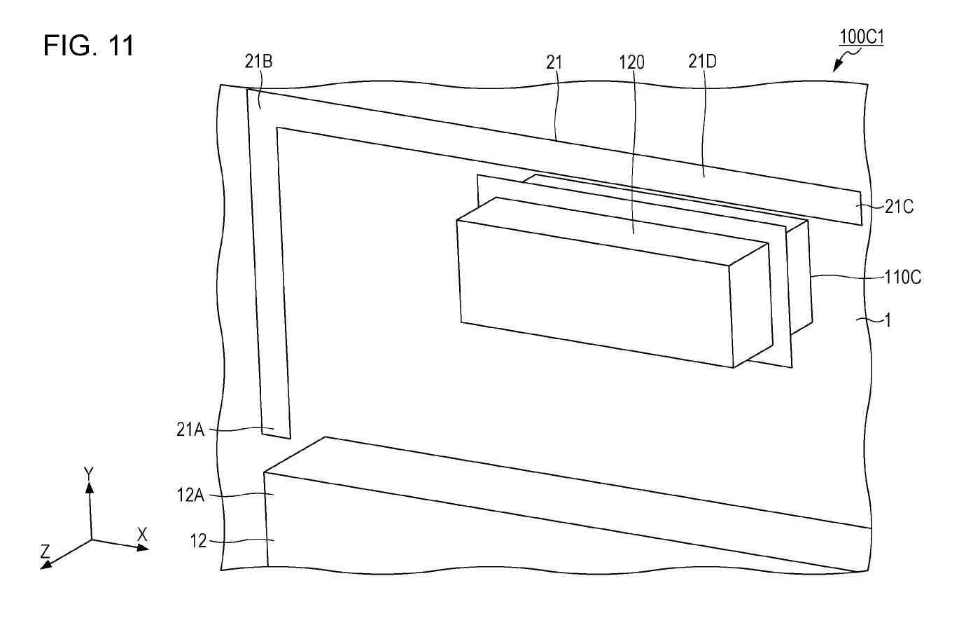

FIG. 11 illustrates an antenna device 100C1 according to a modification of Embodiment 2.

The antenna device 100C1 includes the antenna element 21, the ground plane 12, the floating element 110C and a magnetic material 120.

The antenna element 21 and the floating element 110C illustrated in FIG. 11 are the same as the antenna element 21 and the floating element 110C of the antenna device 100C illustrated in FIG. 10B and are arranged at a position corresponding to the anti-node 21D of the resonant current in the antenna element 21.

The magnetic material 120 is a member formed of rectangular parallelepiped shaped magnetic material that is inserted into the loop formed by the floating element 110C. As an example, the magnetic material 120 has a rectangular parallelepiped shape having a longitudinal direction that extends in the X axis direction and the shapes of side surfaces and a cross section that are parallel to the YZ plane are substantially square. The magnetic material 120 is inserted into the inside of the rectangular loop-shaped floating element 110C. For example, ferrite, iron oxide, chromium oxide or cobalt may be processed into a rectangular parallelepiped shape and used as the magnetic material 120.

Here, the magnetic material 120 is inserted into the inside of the rectangular loop-shaped floating element 110C in order to increase the current flowing in the floating element 110C by increasing (concentrating) the magnetic flux passing through the loop of the floating element 110C. This is done with the aim of reducing the SAR even more.

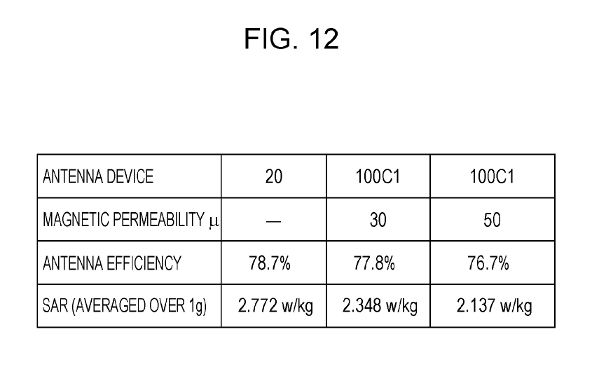

FIG. 12 illustrates the SAR and antenna efficiency in Embodiment 2. In FIG. 12, the antenna efficiency and SAR of the antenna device 20, which is for comparison, (refer to FIG. 10A) and the SARs and antenna efficiencies of two antenna devices 100C1 (refer to FIG. 11), in which the magnetic permeability μ of the magnetic material 120 is respectively set to 30 and 50, are illustrated.

As illustrated in FIG. 12, the antenna efficiency and the SAR of the antenna device 20 (refer to FIG. 10A) were 78.7% and 2.772 w/kg, respectively. This is the same as the result illustrated in FIG. 10C.

The antenna efficiency and the SAR of the antenna device 100C1 in which the magnetic permeability μ of the magnetic material 120 was set to 30 were 77.8% and 2.348 w/kg, respectively, and the antenna efficiency and the SAR of the antenna device 100C1 in which the magnetic permeability μ of the magnetic material 120 was set to 50 were 76.7% and 2.137 w/kg, respectively.

Thus, the antenna efficiencies of the two antenna devices 100C1 in which the magnetic permeabilities μ of the magnetic material 120 were set to 30 and 50 are substantially the same or higher than the antenna efficiency of the antenna device 20 and the difference in antenna efficiency would not be a problem practically.

In addition, the SARs of the two antenna devices 100C1 in which the magnetic permeabilities μ of the magnetic material 120 are set to 30 and 50 were substantially lower than the SAR of the antenna device 20. In particular, the SAR of the antenna device 100C1 in which the magnetic permeability μ of the magnetic material 120 is set to 50 was substantially improved from the SAR of the antenna device 20 and was reduced by around 22.9%.

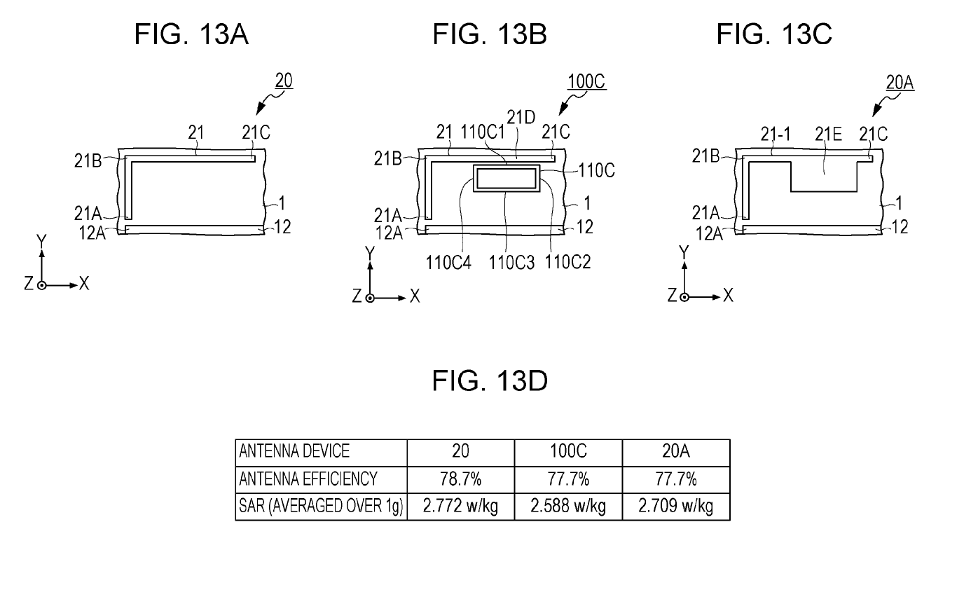

FIGS. 13A to 13D are diagrams for explaining an SAR reduction effect. In FIGS. 13A to 13C, the same XYZ coordinate system is used as in the other drawings.

The antenna device 20 illustrated in FIG. 13A is the same as the antenna device 20 for comparison illustrated in FIG. 10A and includes the antenna element 21 and the ground plane 12.

The antenna device 100C illustrated in FIG. 13B includes the antenna element 21, the ground plane 12 and the floating element 110C. The antenna device 100C illustrated in FIG. 13B is the same as the antenna device 100C of the Embodiment 2 illustrated in FIG. 10B.

Furthermore, an antenna device 20A, which is for comparison, illustrated in FIG. 13C includes an antenna element 21-1 and the ground plane 12. The antenna element 21-1 of the antenna device 20A illustrated in FIG. 13C has a wide portion 21E. The wide portion 21E is obtained by integrating the floating element 110C illustrated in FIG. 13B with the antenna element 21 and increasing the width of the antenna element 21-1 up to a position corresponding to the outer dimension of the floating element 110C when looking at the XY plane.

The obtained simulation results for antenna efficiency (radiation efficiency) and SAR for these antenna devices 20, 100C and 20A are illustrated in FIG. 13D.

As illustrated in FIG. 13D, the antenna efficiency and the SAR of the antenna device 20 were 78.5% and 2.772 w/kg, respectively. The antenna efficiency and the SAR of the antenna device 100C were 77.7% and 2.588 w/kg, respectively. The antenna efficiency and the SAR of the antenna device 20A were 77.7% and 2.709 w/kg, respectively.

Thus, the antenna efficiencies of the antenna devices 220, 100C and 20A were similar. On the other hand, regarding the SARs of the antenna devices 20, 100C and 20A, the SAR of the antenna device 100C was lower than the SARs of the antenna devices 20 and 20A.

As described above, it is clear that the value of SAR may be reduced while maintaining the antenna efficiency (radiation efficiency) by arranging the rectangular loop-shaped floating element 110C at a position corresponding to the anti-node 21D of the resonant current in the antenna element 21.

As described above, according to Embodiment 2, antenna devices 100C and 100C1 may be provided that cause the SAR distribution to be dispersed, due to containing the floating element 110C, while maintaining the radiation efficiency.

In particular, as illustrated in FIG. 11, in the case where the magnetic material 120 is used, the SAR is reduced by around 20% to around 2.1 w/kg for the antenna device 100C1 with respect to the SAR of the antenna device 20 for comparison (around 2.7 w/kg).

In order to reduce the SAR by around 20% in the antenna device 20, the antenna element 11 would have to be spaced an additional 0.9 mm (distance of up to 10.9 mm) from the surface 1A of the phantom 1.

If we consider a case in which the antenna device 20 is employed in a tablet computer, since the thickness of a tablet computer is around 8 to 10 mm, increasing the thickness of the tablet computer by 0.9 mm in order to separate the antenna element 11 by 0.9 mm from the phantom 1 would be equivalent to increasing the thickness of the tablet computer by around 10%.

Therefore, if the antenna device 100C1 were employed in the tablet computer instead of the antenna device 20, the thickness of the tablet computer would be able to be reduced by around 10%.

Therefore, the antenna device 100C1 of Embodiment 2 is able to contribute to reducing the thickness of tablet computers and therefore the utility value thereof is very high.

Although the degree of thickness reduction that would be achieved with the antenna device 100C of Embodiment 2 (refer to FIG. 10B (omitting magnetic material 120)) or the antenna device 100A, 100A1, 100B or 100B1 of Embodiment 1 would be somewhat smaller than would be achieved with the antenna device 100C1, these antenna devices would also be able to contribute to substantially reducing the thickness of a tablet computer.

In addition, although an inverted L-shaped antenna element 21 is used in Embodiment 2, the antenna element 21 is not limited to having an inverted L shape and could have an inverted F shape, for example. The antenna element 21, which bends between the feeding point 21A and the tip 21C, is easy to mount even when there is limited space compared with the antenna element 11 of the embodiment.

Antenna devices of illustrative embodiments have been described above, but the embodiments are not limited to the specific disclosed embodiments and various modifications and changes may be made without departing from the scope of the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An antenna device, comprising:
an antenna element that has a feeding point; and
a floating conductive element that is arranged so as to extend in a direction in which a current flows in the antenna element and in vicinity of the antenna element at a position corresponding to an anti-node of the current, and that is configured to relax a current distribution at the anti-node and around the anti-node.

2. The antenna device according to claim 1, wherein
the floating conductive element is line shaped and has a length that is less than half a wavelength at a communication frequency of the antenna element.

3. The antenna device according to claim 1, wherein
the floating conductive element is loop shaped and has a length that is less than a wavelength at a communication frequency of the antenna element.

4. The antenna device according to claim 3, further comprising:
a magnetic material that is arranged inside the loop of the floating conductive element.

5. The antenna device according to claim 1, wherein
the floating conductive element is provided in a plurality.

6. The antenna device according to claim 5, wherein
the plurality of floating conductive elements are arranged three-dimensionally with respect to the antenna element.

7. The antenna device according to claim 1, further comprising:
a ground plate that is configured to electromagnetic-field couple with the monopole antenna, wherein
the antenna element is a monopole antenna.

8. The antenna device according to claim 7, wherein
the monopole antenna has a line shape, an inverted L shape, or an inverted F shape.

9. The antenna device according to claim 1, wherein
the antenna element is a dipole antenna.
